(19) United States
(12) Patent Application Publication
(10) Pub. No.: US 2021/0264342 A1
(43) Pub. Date: Aug. 26, 2021

(54) Method, Computer Apparatus, And Storage Medium For Evaluating Product Reliability

(71) Applicant: China Electronics Prod Reliability & Environmental Testing Res Inst The Fifth Electronics Res Inst, Guangzhou City (CN)

(72) Inventors: Fan Wu, Guangzhou City (CN); Guojian Nie, Guangzhou City (CN); Jianwei Zhang, Guangzhou City (CN); Ning Hu, Guangzhou City (CN); Bingquan Chen, Guangzhou City (CN)

(73) Assignee: China Electronics Prod Reliability & Environmental Testing Res Inst The Fifth Electronics Res Inst, Guangzhou City (CN)

(21) Appl. No.: 17/036,521

(22) Filed: Sep. 29, 2020

(30) Foreign Application Priority Data
Feb. 21, 2020 (CN) 202010108040.3

(51) Int. Cl. G06Q 10/06; G06F 7/58; G05B 23/02

(52) U.S. Cl. CPC G06Q 10/06395; G06Q 10/067; G06F 16/22; G05B 23/0243; G06F 7/58

(57) ABSTRACT

A method for evaluating product reliability includes: acquiring a second fault simulation result data; performing distribution fitting to the second fault simulation result data to determine the fault distribution function of each of the preset components; performing data sampling according to the first preset random number set and the fault distribution function to obtain the fault distribution function and the fault distribution parameter value set of each PCBA; performing data sampling according to the second random number set and the fault distribution function of each PCBA to obtain a fault distribution function and a fault distribution parameter value set of the product; and obtaining a product reliability evaluation result.

### CROSS-REFERENCE TO RELATED APPLICATIONS

The present application claims priority from Chinese Patent Application No. 2020101080403, filed Feb. 21, 2020, the disclosure of which is hereby incorporated herein by reference.

### TECHNICAL FIELD

The present disclosure relates to the technical field of computer, and more particularly, to a method, a computer apparatus and a storage medium for evaluating product reliability.

### BACKGROUND

With the development of fault physics research, product reliability evaluation technology based on fault physics has emerged. Product reliability evaluation refers to carrying out fault prediction based on the fault physics model and obtaining product reliability evaluation results.

In the conventional product reliability evaluation technology, after obtaining the pre-failure time and the main failure mechanism of the product evaluation, it is assumed that the product follows a certain function distribution. Using the formula of the function distribution, the reliability function of the product is fitted to obtain the reliability function of the product, the point estimation values of the failure time and the failure rate of the product is obtained according to the function distribution, and the reliability of the product is evaluated according to the point estimation values.

However, the method for evaluating conventional product reliability has the problem of inaccurate evaluation because it only relies on a certain assumed function distribution and a point estimation value to evaluate the reliability of the product.

### SUMMARY

According to various embodiments, a method, a device, a computer apparatus, and a storage medium for evaluating product reliability are provided.

A method for evaluating product reliability includes:

acquiring a first fault simulation result data of each preset component;

obtaining a second fault simulation result data of each of the preset components according to an identification of each fault simulation result data in the first fault simulation result data;

performing distribution fitting to the second fault simulation result data to determine the fault distribution function of each of the preset components;

performing data sampling according to a first preset random number set and the fault distribution function of each of the preset components, and performing distribution fitting to the PCBA (printed circuit board assembly)-level fault simulation result data obtained after sampling to obtain the fault distribution function and fault distribution parameter value set of each PCBA, the fault distribution parameter value set includes a fault distribution parameter, a point estimation value and upper and lower limit interval values of the failure time;

performing data sampling according to a second preset random number set and the fault distribution function of each PCBA, and performing distribution fitting to the product-level fault simulation result data obtained after sampling to obtain a fault distribution function and a fault distribution parameter value set of the product; and

obtaining a product reliability evaluation result according to the fault distribution function and the fault distribution parameter value set of each PCBA and the fault distribution function and the fault distribution parameter value set of the product.

In one of the embodiments, acquiring the first fault simulation result data of each of the preset components includes:

acquiring a reliability simulation result data of the product, and determining a failure mechanism priority according to the reliability simulation result data;

determining a failure mechanism to be analyzed according to the failure mechanism priority and a preset failure mechanism number to be analyzed;

acquiring a first fault simulation result data of each of the preset components from the reliability simulation result data according to the failure mechanism to be analyzed.

In one of the embodiments, obtaining the second fault simulation result data of each of the preset components according to the identification of each fault simulation result data in the first fault simulation result data includes:

determining a fault simulation result data corresponding to each failure mechanism to be analyzed according to the identification of each fault simulation result data in the first fault simulation result data; and

pre-processing the fault simulation result data corresponding to each failure mechanism to be analyzed, and obtaining the second fault simulation result data of each of the preset components according to the pre-processed fault simulation result data.

In one of the embodiments, the performing distribution fitting to the second fault simulation result data to determine the fault distribution function of each of the preset components includes:

obtaining a hypothesis function set of each of the preset components according to the second fault simulation result data of each of the preset components; and

performing fitting testing to each hypothesis function in the hypothesis function set, and selecting the fault distribution function from the hypothesis function set according to the fitting test result.

In one of the embodiments, the performing data sampling according to the first preset random number set and the fault distribution function of each of the preset components includes:

obtaining the failure time of each of the preset components corresponding to each first random number according to each first random number in the first preset random number set and the fault distribution function of each of the preset components;

sorting the failure time of each of the preset components and selecting a smallest failure time therefrom as the failure time corresponding to each first random number;

obtaining the PCBA-level fault simulation result data according to the failure time corresponding to each first random number.

In one of the embodiments, the performing distribution fitting to the PCBA-level fault simulation result data obtained after sampling to obtain the fault distribution function and the fault distribution parameter value set of each PCBA includes:

performing distribution fitting to the PCBA-level fault simulation result data obtained after sampling to obtain the fault distribution function of each PCBA;

obtaining a point estimation value, upper and lower limit interval values, and the failure time function of the fault distribution parameter of each PCBA according to the fault distribution function of each PCBA; and

obtaining a point estimation value and upper and lower limit interval values of the failure time of each PCBA according to the point estimation value, the upper and lower limit interval values and the failure time function of the fault distribution parameter of each PCBA.

In one of the embodiments, the performing data sampling according to the second preset random number set and the fault distribution function of each PCBA, and performing distribution fitting to the product-level fault simulation result data to obtain the fault distribution function and the fault distribution parameter value set of the product includes:

obtaining the failure time of each PCBA corresponding to each second random number according to each second random number in the second preset random number set and the fault distribution function of each PCBA;

sorting the failure time of each PCBA and selecting a smallest failure time therefrom as the failure time corresponding to each second random number;

obtaining a product-level fault simulation result data according to the failure time corresponding to each second random number.

performing distribution fitting to the product-level fault simulation result data obtained after sampling to obtain the fault distribution function of the product;

obtaining a point estimation value, upper and lower limit interval values and the failure time function of the fault distribution parameter of the product according to the fault distribution function of the product; and

obtaining a point estimation value and the upper and lower limit interval values of the failure time of the product according to the point estimation value, the upper and lower limit interval values and the failure time function of the fault distribution parameter of the product.

A computer apparatus including a memory and a processor is provided. The memory is stored with computer programs, and the steps below will be implemented when the processor executes the computer programs:

acquiring a first fault simulation result data of each of the preset components;

obtaining a second fault simulation result data of each of the preset components according to an identification of each fault simulation result data in the first fault simulation result data;

performing distribution fitting to the second fault simulation result data to determine the fault distribution function of each of the preset components;

performing data sampling according to a first preset random number set and the fault distribution function of each of the preset components, and performing distribution fitting to the PCBA-level fault simulation result data obtained after sampling to obtain a fault distribution function and a fault distribution parameter value set of each PCBA, the fault distribution parameter value set includes a fault distribution parameter, a point estimation value and the upper and lower limit interval values of the failure time;

performing data sampling according to a second preset random number set and the fault distribution function of each PCBA, and performing distribution fitting to the product-level fault simulation result data obtained after sampling to obtain a fault distribution function and a fault distribution parameter value set of the product; and

obtaining a product reliability evaluation result according to the fault distribution function and the fault distribution parameter value set of each PCBA and the fault distribution function and the fault distribution parameter value set of the product.

At least one non-transitory computer-readable storage medium storing computer-readable instructions that, when executed by at least one processors, cause the at least one processor to perform steps including:

acquiring a first fault simulation result data of each of the preset components;

obtaining a second fault simulation result data of each of the preset components according to an identification of each fault simulation result data in the first fault simulation result data;

performing distribution fitting to the second fault simulation result data to determine the fault distribution function of each of the preset components;

performing data sampling according to a first preset random number set and the fault distribution function of each of the preset components, and performing distribution fitting to the PCBA-level fault simulation result data obtained after sampling to obtain a fault distribution function and a fault distribution parameter value set of each PCBA, the fault distribution parameter value set includes a fault distribution parameter, a point estimation value and the upper and lower limit interval values of the failure time;

performing data sampling according to a second preset random number set and the fault distribution function of each PCBA, and performing distribution fitting to the product-level fault simulation result data obtained after sampling to obtain a fault distribution function and a fault distribution parameter value set of the product; and

obtaining a product reliability evaluation result according to the fault distribution function and the fault distribution parameter value set of each PCBA and the fault distribution function and the fault distribution parameter value set of the product.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a schematic diagram illustrating an environment adapted for a method for evaluating product reliability according to one of the embodiments;

FIG. 2 is a flowchart illustrating a method for evaluating product reliability according to one of the embodiments;

FIG. 3 is a flowchart illustrating a method for evaluating product reliability according to one of the embodiments;

FIG. 4 is a schematic diagram illustrating a method for evaluating product reliability according to one of the embodiments;

FIG. 5 is a block diagram of a device for evaluating product reliability according to one of the embodiments;

FIG. 6 is a block diagram of a computer apparatus for evaluating product reliability according to one of the embodiments.

### DETAILED DESCRIPTION OF THE EMBODIMENTS

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention.

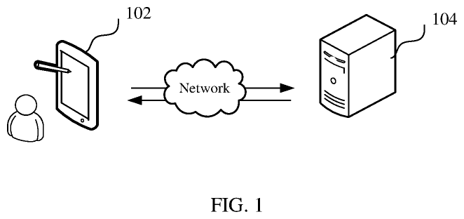

In one embodiment, a method for evaluating product reliability is provided, which can be implemented in the environment shown in FIG. 1. A terminal 102 communicates with a server 104 via a network. The server 104 acquires a first fault simulation result data of each preset component from the terminal 102, and obtains a second fault simulation result data of each of the preset components according to an identification of each fault simulation result data in the first fault simulation result data. A distribution fitting is performed on the second fault simulation result data to determine the fault distribution function of each of the preset components, and a data sampling is performed according to the first preset random number set and the fault distribution function of each of the preset components. A distribution fitting is performed on the PCBA-level fault simulation result data obtained after sampling to obtain a fault distribution function and a fault distribution parameter value set of each PCBA. The fault distribution parameter value set includes a fault distribution parameter, a point estimation value and upper and lower limit interval values of the failure time. A data sampling is performed according to the second preset random number set and the fault distribution function of each PCBA, and a distribution fitting is performed on the product-level fault simulation result data obtained after sampling to obtain a fault distribution function and a fault distribution parameter value set of the product. A product reliability evaluation result is obtained according to the fault distribution function and the fault distribution parameter value set of each PCBA and the fault distribution function and the fault distribution parameter value set of the product. The terminal 102 can be, but not limited to, at least one of the personal computer, laptop, smart phone, tablet computer, and portable wearable device, and the server 104 may be implemented as a stand-alone server or a server cluster composed of multiple servers.

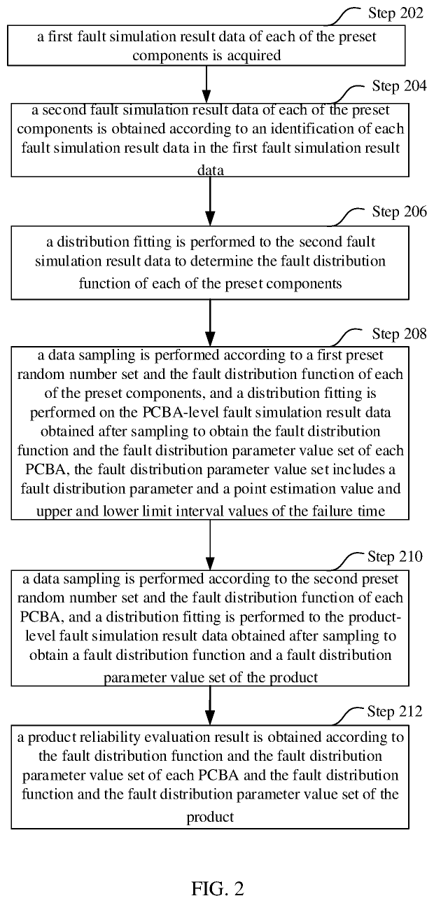

In one embodiment, referring to FIG. 2, a method for evaluating product reliability is provided. The method can be applied to the server in FIG. 1, which includes the following steps:

In step 202, a first fault simulation result data of each of the preset components is acquired.

The preset component refers to a component model in a reliability simulation model based on fault physics, and the number and type of the preset components can be configured according to users' needs. The first failure simulation result data refers to a part of the reliability simulation result data obtained after the reliability simulation experiment based on fault physics, which can be determined by the failure mechanism. For example, when the failure mechanism is caused by thermal stress, the first failure simulation result data may specifically be the number of thermal cycles. For another example, when the failure mechanism is caused by vibration stress, the first fault simulation result data may specifically be the vibration time.

Specifically, after the reliability simulation experiment based on fault physics is completed, the server will determine the failure mechanism priority of the preset components according to the reliability simulation result data, and then a part of the data that meets the requirements is screened as the first fault simulation result data of the preset components from the reliability simulation result data according to the preset failure mechanism number to be analyzed. The failure mechanism number to be analyzed can be set as required. For example, when the failure mechanism number to be analyzed is 2, the server will screen the data corresponding to two failure mechanisms with the highest priority from the reliability simulation data according to the failure mechanism priority. For example, the server can use the Monte Carlo method to screena part of the data that meets the requirements from the reliability simulation result data as the first failure simulation result data of the preset component.

In step 204, a second fault simulation result data of each of the preset components is obtained according to an identification of each fault simulation result data in the first fault simulation result data.

The identification of each fault simulation result data is used to identify each fault simulation result data. For example, the identification may specifically be a unit of data for each fault simulation result. For example, when the failure mechanism is caused by thermal stress, the identification of the fault simulation result data may specifically be a cycle number of thermal cycles. For another example, when the failure mechanism is caused by vibration stress, the identification of the fault simulation result data may specifically be vibration time. The second fault simulation result data of each of the preset components refers to a fault simulation result data obtained after synthesizing each failure mechanism. For example, the second fault simulation result data may specifically refer to the failure time of each of the preset components.

Specifically, after obtaining the first fault simulation result data, the server will classify each fault simulation result data according to the identification of each fault simulation result data in the first fault simulation result data, and determine the fault simulation result data corresponding to each failure mechanism to be analyzed, and pre-process the fault simulation result data corresponding to each failure mechanism to be analyzed. The pre-processing herein refers to the conversion of a part of the failure simulation result data. Since the second failure simulation result data refers to the failure simulation result data obtained after synthesizing each failure mechanism, which can be specifically the failure time, when the unit of the fault simulation result data corresponding to the a certain failure mechanism is not a time unit, the server will convert the part of fault simulation result data to data in the unit of time. For example, the unit of failure simulation result data corresponding to the failure mechanism causing by thermal stress is the cycle number of thermal cycles, and the server will convert the failure simulation result data according to the thermal cycle time. After the conversion is completed, the server will obtain the second fault simulation result data according to the component failure principle.

In step 206, A distribution fitting is perform to the second fault simulation result data to determine the fault distribution function of each of the preset components.

The performing distribution fitting to the second fault simulation result data refers to determining the distribution function closest to the data distribution of the second fault simulation result data. The distribution function may specifically be a normal distribution function, an exponential distribution function, a logarithmic distribution function, a two-parameter Weibull distribution function, a three-parameter Weibull distribution function, and so on. The fault distribution function of each of the preset components refers to a distribution function used to represent the data distribution of the second fault simulation result data of each of the preset components.

Specifically, the server will perform distribution fitting to the second fault simulation result data, determine the distribution function closest to the data distribution of the second fault simulation result data, and use the closest distribution function as the fault distribution of the preset component function.

In step 208, a data sampling is performed according to a first preset random number set and the fault distribution function of each of the preset components, and a distribution fitting is performed to the PCBA-level fault simulation result data obtained after sampling to obtain the fault distribution function and the fault distribution parameter value set of each PCBA, the fault distribution parameter value set includes a fault distribution parameter, a point estimation value and upper and lower limit interval values of the failure time.

The first preset random number set refers to a preset random number set, which can be configured as needed. Performing data sampling refers to selecting the fault simulation result data corresponding to each first random number according to each random number in the first preset random number set and the fault distribution function of each of the preset components. The PCBA-level fault simulation result data refers to a fault simulation result data set corresponding to each first random number. The performing distribution fitting to the PCBA-level fault simulation result data obtained after sampling refers to determining the distribution function closest to the data distribution of the PCBA-level fault simulation result data. The distribution function may specifically be a normal distribution function, an exponential distribution function, a logarithmic distribution function, a two-parameter Weibull distribution function, a three-parameter Weibull distribution function, and so on. The fault distribution function of PCBA refers to a distribution function used to represent a data distribution of the PCBA-level fault simulation result data. The failure time refers to the time when the product loses its effectiveness. The point estimation value refers to the specific value of the failure time, and the upper and lower limit interval values refer to a value of the failure time range. The fault distribution parameter value set may specifically refer to a fault distribution parameter value set under a specified preset confidence coefficient. The preset confidence coefficient refers to the confidence coefficient that is preset. For example, the preset confidence coefficient can be 95%.

Specifically, the server will acquire the fault simulation result data of each of the preset components corresponding to each first random number according to the first random number in the first preset random number set and the fault fraction function of each of the preset components, sort the fault simulation result data of each of the preset components corresponding to each first random number, select the fault simulation result data from the fault simulation result data of each of the preset components corresponding to each first random number according to the sorting result, and use the fault simulation result data set corresponding to each random number as the PCBA-level fault simulation result data. The failure simulation result data of each of the preset components corresponding to each first random number may specifically be the failure time of each of the preset components. For example, the server can use the Monte Carlo method and the fault distribution function of each of the preset components to perform data sampling. After obtaining the PCBA-level fault simulation result data, the server will perform distribution fitting to the PCBA-level fault simulation result data, determine the distribution function closest to the data distribution of the PCBA-level fault simulation result data, and use the closest distribution function as the fault distribution function of each PCBA, and obtain a fault distribution parameter value set according to the fault distribution function and the preset confidence coefficient.

In step 210, a data sampling is performed according to the second preset random number set and the fault distribution function of each PCBA, and a distribution fitting is performed to the product-level fault simulation result data obtained after sampling to obtain a fault distribution function and a fault distribution parameter value set of the product.

The second preset random number set refers to a random number set that is preset, which can be configured as needed. Performing data sampling refers to selecting the fault simulation result data corresponding to each second random number according to each random number in the second preset random number set and the fault distribution function of each PCBA. Product-level fault simulation result data refers to a fault simulation result data set corresponding to each second random number. The performing distribution fitting to the product-level fault simulation result data obtained after sampling refers to determining a distribution function closest to a data distribution of the product-level fault simulation result data. The distribution function may specifically be a normal distribution function, an exponential distribution function, a logarithmic distribution function, a two-parameter Weibull distribution function, a three-parameter Weibull distribution function, and so on. The fault distribution function of the product refers to a distribution function used to represent the data distribution of the product-level fault simulation result data.

Specifically, the server will acquire the fault simulation result data of each of the preset components corresponding to each second random number according to the second random number in the second preset random number set and the fault distribution function of each PCBA, sort the fault simulation result data of each PCBA corresponding to each second random number, select the fault simulation result data from the fault simulation result data of each PCBA corresponding to each second random number according to the sorting result, and use the fault simulation result data set corresponding to each second random number as the PCBA-level fault simulation result data. The failure simulation result data of each PCBA corresponding to each second random number may specifically be the failure time of each PCBA. For example, the server can use the Monte Carlo method and the fault distribution function of each PCBA to perform data sampling. After obtaining the product-level fault simulation result data, the server will perform distribution fitting to the product-level fault simulation result data, determine the distribution function closest to the data distribution of the product-level fault simulation result data, and use the closest distribution function as the fault distribution function of the product, and obtain a fault distribution parameter value set according to the fault distribution function and the preset confidence coefficient.

In step 212, a product reliability evaluation result is obtained according to the fault distribution function and the fault distribution parameter value set of each PCBA and the fault distribution function and the fault distribution parameter value set of the product.

The product reliability evaluation results include a fault distribution function and a fault distribution parameter value set of each PCBA, a fault distribution function and a fault distribution parameter value set of the product, and a fault distribution function, a fault distribution parameter value set and so on of each of the preset components in the PCBA. The fault distribution parameter value set of the preset components can be obtained by the fault distribution function of the preset components.

Specifically, the server will calculate the fault distribution function and fault distribution parameter value set of each PCBA, the fault distribution function and the fault distribution parameter value set of the product, and the fault distribution function and fault distribution parameter value set of each of the preset components in the PCBA to obtain the product reliability evaluation results.

In the aforementioned method for evaluating product reliability, the first fault simulation result data of each of the preset components is acquired, and the second fault simulation result of each of the preset components is obtained according to the identification of each fault simulation result data in the first fault simulation result data. Then via performing distribution fitting to the second fault simulation result data, the accurate determination of the fault distribution function of each of the preset components is realized, and the accuracy of the evaluation is improved. After the fault distribution function of each of the preset components is obtained, a data sampling is performed according to the first preset random number set and the fault distribution function of each of the preset components to obtain the fault distribution function and the fault distribution parameter value set of each PCBA, and a data sampling is performed according to the second preset random number set and the fault distribution function of each PCBA, and a distribution fitting is performed on the product-level fault simulation result data obtained after sampling to realize the accurate determination of the fault distribution function and the fault distribution parameter value set of the product, which improves the accuracy of the evaluation. After obtaining the accurate fault distribution function and the fault distribution parameter value set of the product, the product reliability evaluation result is obtained according to the fault distribution function and the fault distribution parameter value set of each PCBA, and the fault distribution function and the fault distribution parameter value set of the product. The product reliability is evaluated from multi angles such as the point estimation value and the upper and lower limit interval values of the failure time of various PCBAs and products, so as to achieve an accurate evaluation of product reliability.

In one embodiment, the step of acquiring the first fault simulation result data of each of the preset components includes:

acquiring a reliability simulation result data of the product, and determining a failure mechanism priority according to the reliability simulation result data;

determining a failure mechanism to be analyzed according to the failure mechanism priority and a preset failure mechanism number to be analyzed;

acquiring the first failure simulation result data of each of the preset components from the reliability simulation result data according to the failure mechanism to be analyzed.

The reliability simulation result data of the product refers to the experimental results obtained after performing reliability simulation experiments based on a fault physics according to the components and structures of the product. The failure mechanism refers to the cause of failure.

Specifically, the server will acquire the reliability simulation result data of the product from the terminal, and read the failure mechanism priority from the reliability simulation result data. The failure mechanism priority of each of the preset components can be directly read from the reliability simulation result data. The failure mechanism priority is determined according to the degree of damage, with the highest degree of damage having the highest priority. After obtaining the failure mechanism priority of each of the preset components, the server will determine the failure mechanism to be analyzed according to the preset failure mechanism number to be analyzed, and acquire the first fault simulation result data of each of the preset components from the reliability simulation result data according to the failure mechanism to be analyzed. Each simulation result data in the reliability simulation result data carries a data identification, and the component to which the simulation result data belongs can be determined by the data identification.

In this embodiment, the failure mechanism priority is determined by the reliability simulation result data, the failure mechanism to be analyzed is determined according to the failure mechanism priority and the preset failure mechanism number to be analyzed, and acquiring the first fault simulation result data of each of the preset components from the reliability simulation result data according to the failure mechanism to be analyzed can realize the acquiring of the first fault simulation result data of each of the preset components.

In one embodiment, the step of obtaining the second fault simulation result data of each of the preset components according to the identification of each fault simulation result data in the first fault simulation result data includes:

determining a fault simulation result data corresponding to each failure mechanism to be analyzed according to the identification of each fault simulation result data in the first fault simulation result data; and

pre-processing the fault simulation result data corresponding to each failure mechanism to be analyzed, and obtaining the second fault simulation result data of each of the preset components according to the pre-processed fault simulation result data.

The failure mechanism to be analyzed refers to the failure mechanism that is determined according to the failure mechanism priority and the preset failure mechanism number to be analyzed of the preset component, and is used for reliability evaluation of the product. The pre-processing the fault simulation result data corresponding to each failure mechanism to be analyzed refers to converting the fault simulation result data and converting all the fault simulation result data corresponding to the failure mechanism into data represented in the same unit. The pre-processed fault simulation result data refers to the fault simulation result data that has been converted into the same unit and corresponds to each failure mechanism to be analyzed. For example, the same unit may specifically be a time unit, including days, hours, minutes and so on.

Specifically, after obtaining the first fault simulation result data, the server will classify each fault simulation result data according to the identification of each fault simulation result data in the first fault simulation result data, and determine the fault simulation result data corresponding to each failure mechanism to be analyzed, and pre-process the fault simulation result data corresponding to each failure mechanism to be analyzed. The identification of each fault simulation result data may specially refer to the unit of each fault simulation result data. For example, the unit of the failure simulation result data corresponding to the failure mechanism causing by thermal stress is the cycle number of cycles of the thermal cycle, and the unit of the failure simulation result data corresponding to the failure mechanism causing by vibration stress is hour. The sever can distinguish between the fault simulation result data corresponding to causing by thermal stress and causing by vibration stress and the corresponding caused by vibration stress via unit.

Specially, the pre-processing refers to the conversion of a part of the failure simulation result data. Since the second failure simulation result data refers to the failure simulation result data obtained after synthesizing each failure mechanism, which can be specifically the failure time, when the unit of the fault simulation result data corresponding to a certain failure mechanism to be analyzed is not a time unit, the server will convert the part of fault simulation result data to data in the unit of time. For example, the unit of failure simulation result data corresponding to the failure mechanism causing by thermal stress is the cycle number of thermal cycles, and the server will convert the failure simulation result data according to the thermal cycle time. After the conversion is completed, the server will obtain the second fault simulation result data according to the component failure principle.

For example, for each of the preset components, it is generally assumed that its failure follows an exponential distribution, the failure rate is constant, and the failure rate is the sum of the failure rates of each failure mechanism. When there are two failure mechanisms, the formula for the failure rate λλλ of any preset component is

$$λ = \frac{1}{M T B F} = {λ}_{1} + {λ}_{2} = \frac{1}{{MTBF}_{1}} + \frac{1}{{MTBF}_{2}} \text{:}$$

where λ₁ and λ₂ are the first and the second failure mechanisms of the preset component, MTBF refers to the failure time. Through the aforementioned formula, the failure time of the preset component, that is, the second fault simulation result data can be obtained.

In this embodiment, through the identification of each fault simulation result data in the first fault simulation result data, the fault simulation result data corresponding to each failure mechanism to be analyzed is determined, and the fault simulation result data corresponding to each failure mechanism to be analyzed is pre-processed. The second fault simulation result data of each of the preset components can be acquired according to the pre-processed fault simulation result data.

In one of the embodiments, the step of pre-processing the fault simulation result data corresponding to each failure mechanism to be analyzed includes:

When the failure mechanism to be analyzed is caused by thermal stress, the fault simulation result data corresponding to be caused by the thermal stress is pre-processed according to the preset temperature profile time.

The thermal stress refers to the stress generated by the object due to the inability of fully expansion and contraction caused by external constraints and mutual constraints between the internal parts when the temperature changes, also known as the variable temperature stress. The temperature profile refers to the temperature distribution along a spatial cross section at a given moment. The preset temperature profile time is preset and can be set according to need.

Specifically, when the failure mechanism to be analyzed is caused by thermal stress, the server will pre-process the fault simulation result data corresponding to causing by thermal stress via a method of multiplying the preset temperature profile time and the fault simulation result data corresponding to the thermal stress to obtain the failure time corresponding to the thermal stress.

In this embodiment, performing pre-processing on the fault simulation result data corresponding to causing by thermal stress can be realized via presetting the temperature profile time.

In one of the embodiments, the step of performing distribution fitting to the second fault simulation result data to determine the fault distribution function of each of the preset components includes:

obtaining a hypothesis function set of each of the preset components according to the second fault simulation result data of each of the preset components;

performing fitting testing to each hypothesis function in the hypothesis function set, and selecting the fault distribution function from the hypothesis function set according to the fitting test result.

The hypothesis function set refers to a hypothesis function set for each of the preset components. The hypothesis function refers to a function that the data distribution of the second fault simulation result data of each of the hypothesis preset components satisfies, which may be a normal distribution function, an exponential distribution function, a logarithmic distribution function, a two-parameter Weibull distribution function, a three-parameter Weibull distribution and so on. Performing fitting test of each hypothesis function in the hypothesis function set refers to obtaining a fitting test result of each hypothesis function according to the second fault simulation result data and each hypothesis function. For example, the performing fitting test on each hypothesis function in the hypothesis function set may specifically be adopting a preset test method, carrying out a hypothesis testing for each hypothesis function, obtaining a hypothesis test result value, and determine a fitting test result according to the hypothesis test result value of each hypothesis function. The preset inspection method may be the Kolmogorov inspection method.

Specifically, the server will use the maximum likelihood method and the second fault simulation result data of each of the preset components to obtain a hypothesis function set for each of the preset components, and perform a fitting test on each hypothesis function in the hypothesis function set to obtain a hypothesis test result value of each hypothesis function. The fitting test result is determined by comparing the hypothesis test result value of each hypothesis function, and the fault distribution function is selected from the hypothesis function set according to the fitting test result.

For example, the server may call the kstest function in MATLAB and take the second fault simulation result data of each of the preset components and the function formula of each hypothesis function as inputs to obtain the h value and p value used to represent the hypothesis test result. By comparing the h value and the p value corresponding to each hypothesis function, the optimal hypothesis function is determined, and the optimal hypothesis function is used as the fitting test result, that is, the fault distribution function of the preset component. The determining the optimal hypothesis function by comparing the h value and the p value corresponding to each hypothesis function includes: rejecting the hypothesis function with an h value of 1, and selecting the hypothesis function with the largest p value from the hypothesis functions with an h value of 0 as the optimal hypothesis function.

In this embodiment, a hypothesis function set of each of the preset components is obtained according to the second fault simulation result data of each of the preset components. By performing a fitting test on each hypothesis function in the hypothesis function set, the fault distribution function is selected from the hypothesis function set according to the fitting test result to realize the determination of the fault distribution function.

In one of the embodiments, the performing data sampling according to the first preset random number set and the fault distribution function of each of the preset components includes:

obtaining the failure time of each of the preset components corresponding to each first random number according to each first random number in the first preset random number set and the fault distribution function of each of the preset components;

sorting the failure time of each of the preset components and selecting a smallest failure time therefrom as the failure time corresponding to each first random number;

obtaining the PCBA-level fault simulation result data according to the failure time corresponding to each first random number.

The failure time of each of the preset components refers to the time when each of the preset components loses effectiveness.

Specifically, the server will use each first random number in the first preset random number set as a result value of the fault distribution function of each of the preset components, and back-calculates the failure time of each of the preset components corresponding to each first random number, that is the independent variable in the fault score function, according to the result value and the fault distribution function. After obtaining the failure time of each of the preset components corresponding to each first random number, the server sorts the failure time of each of the preset components, and selects a smallest failure time therefrom as a failure time corresponding to each first random number, and finally, a PCBA-level fault simulation result data is obtained by summarizing the failure time corresponding to each first random number. For example, the server may use the Monte Carlo method and the fault distribution function of each of the preset components to obtain the failure time of each of the preset components corresponding to each first random number.

In this embodiment, the failure time of each of the preset components corresponding to each first random number is obtained according to the first random number in the first preset random number set and the fault distribution function of each of the preset components. The failure time of each of the preset components is sorted, and the smallest failure time can be selected as the failure time corresponding to each first random number, thereby obtaining a PCBA-level failure simulation result data according to the failure time corresponding to each first random number, so as to realize the determination of PCBA-level fault simulation result data.

In one of the embodiments, the performing distribution fitting to the PBCA-level fault simulation result data obtained after sampling to obtain the fault distribution function and the fault distribution parameter value set of each PCBA includes:

performing distribution fitting to the PBCA-level fault simulation result data obtained after sampling to obtain the fault distribution function of each PCBA;

obtaining a point estimation value, upper and lower limit interval values and the failure time function of the fault distribution parameter of each PCBA according to the fault distribution function of each PCBA; and

obtaining a point estimation value and the upper and lower limit interval values of the failure time of each PCBA according to the point estimation value, the upper and lower limit interval values and the failure time function of the fault distribution parameter of each PCBA.

The failure time function refers to a function used to represent the change trend of the failure time.

Specifically, the server performs distribution fitting to the PCBA-level fault simulation result data obtained after sampling to obtain the fault distribution function of each PCBA. The distribution fitting method is the same as the distribution fitting method for the second fault simulation result data. For PCBA obeying the fault distribution function F(t), the failure density function is f(t), then the relationship between the two can be obtained: F(t)=∫₀^{t}f(x)dx, the failure time function of the PCBA used to represent MTBF that may be obtained according to the definition of MTBF is: MTBF=∫₀^{co}tf (t)dt. Therefore, according to the fault distribution function of PCBA, the server can calculate the failure time function of PCBA and the point estimation value and the upper and lower limit interval values of the fault distribution parameter. After obtaining the failure time function of PCBA and the point estimation value and the upper and lower limit interval values of the fault distribution parameter, the server can calculate the point estimation value and the upper and lower limit interval values of the failure time of PCBA by bringing the point estimation value and the upper and lower limit interval values of the fault distribution parameter into the failure time function.

In this embodiment, the point estimation value and the upper and lower limit interval values of the fault distribution parameter of each PCBA and the failure time function of each PCBA are obtained according to the fault distribution function of PCBA, and the point estimation value and the upper and lower limit interval values of each PCBA can be calculated via the point estimation value and the upper and lower limit interval values of the failure time of the fault distribution parameter of each PCBA, and the failure time function of each PCBA, which can realize the determination of the fault distribution function and the fault distribution parameter value set of each PCBA.

In one of the embodiments, the performing data sampling according to the second preset random number set and the fault distribution function of each PCBA, and performing distribution fitting to the product-level fault simulation result data to obtain the fault distribution function and the fault distribution parameter value set of the product includes:

obtaining the failure time of each PCBA corresponding to each second random number according to each second random number in the second preset random number set and the fault distribution function of each PCBA;

sorting the failure time of each PCBA and selecting a smallest failure time therefrom as the failure time corresponding to each second random number;

obtaining a product-level fault simulation result data according to the failure time corresponding to each second random number.

performing distribution fitting to the product-level fault simulation result data obtained after sampling to obtain the fault distribution function of the product;

obtaining a point estimation value, upper and lower limit interval values and the failure time function of the fault distribution parameter of the product according to the fault distribution function of the product; and

obtaining a point estimation value and the upper and lower limit interval values of the failure time of the product according to the point estimation value, the upper and lower limit interval values and the failure time function of the fault distribution parameter of the product.

Specifically, the server will use each second random number in the second preset random number set as the result value of the fault distribution function of each PCBA, and back-calculate the failure time of each PCBA corresponding to each first random number, that is the independent variable in the fault fraction function, according to the result value and the fault distribution function. After obtaining the failure time of each PCBA corresponding to each second random number, the server sorts the failure time of each PCBA, and selects a smallest failure time therefrom as a failure time corresponding to each second random number, and finally, a product-level fault simulation result data is obtained by summarizing the failure time corresponding to each second random number. For example, the server may use the Monte Carlo method and the fault distribution function of each PCBA to obtain the failure time of each PCBA corresponding to each second random number.

Specifically, the server performs distribution fitting to the PCBA-level fault simulation result data obtained after sampling to obtain the fault distribution function of each PCBA. The distribution fitting method is the same as the distribution fitting method for the second fault simulation result data. For PCBA obeying the fault distribution function F(t), the failure density function is f(t), then the relationship between the two can be obtained: F(t)=∫₀^{t}f(x)dx, the failure time function of the PCBA used to represent MTBF that may be obtained according to the definition of MTBF is: MTBF=∫₀^{co}tf(t)dt. Therefore, according to the fault distribution function of PCBA, the server can calculate the failure time function of PCBA and the point estimation value and the upper and lower limit interval values of the fault distribution parameter. After obtaining the failure time function of PCBA and the point estimation value and the upper and lower limit interval values of the fault distribution parameter, the server can calculate the point estimation value and the upper and lower limit interval values of the failure time of PCBA by bringing the point estimation value and the upper and lower limit interval values of the fault distribution parameter into the failure time function.

In this embodiment, performing data sampling according to a second preset random number set and the fault distribution function of each PCBA, and performing distribution fitting to the product-level fault simulation result data to obtain the fault distribution function and the fault distribution parameter value set of the product can realize the acquiring of the fault distribution function and the fault distribution parameter value set of the product.

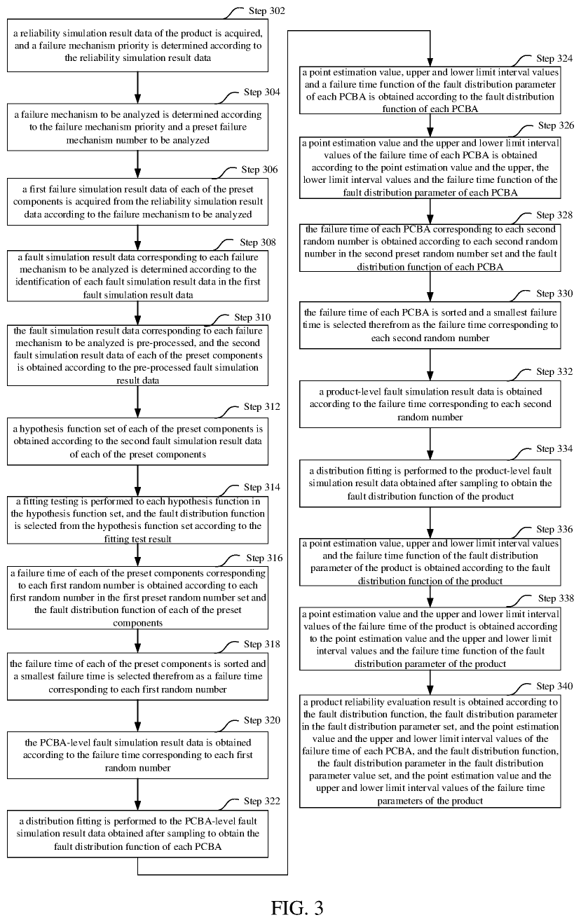

As shown in FIG. 3, the product reliability evaluation method will be illustrated via a most specific embodiment, which specifically includes the following steps:

In step 302, a reliability simulation result data of the product is acquired, and a failure mechanism priority is determined according to the reliability simulation result data;

In step 304, a failure mechanism to be analyzed is determined according to the failure mechanism priority and a preset failure mechanism number to be analyzed;

In step 306, a first failure simulation result data of each of the preset components is acquired from the reliability simulation result data according to the failure mechanism to be analyzed.

In step 308, a fault simulation result data corresponding to each failure mechanism to be analyzed is determined according to the identification of each fault simulation result data in the first fault simulation result data;

In step 310, the fault simulation result data corresponding to each failure mechanism to be analyzed is pre-processed, and the second fault simulation result data of each of the preset components is obtained according to the pre-processed fault simulation result data.

In step 312, a hypothesis function set of each of the preset components is obtained according to the second fault simulation result data of each of the preset components;

In Step 314, a fitting testing is performed to each hypothesis function in the hypothesis function set, and selecting the fault distribution function from the hypothesis function set according to the fitting test result;

In step 316, a failure time of each of the preset components corresponding to each first random number is obtained according to each first random number in the first preset random number set and the fault distribution function of each of the preset components;

In Step 318, the failure time of each of the preset components is sorted and a smallest failure time therefrom is selected as a failure time corresponding to each first random number;

In step 320, the PCBA-level fault simulation result data is obtained according to the failure time corresponding to each first random number;

In step 322, a distribution fitting is performed to the PCBA-level fault simulation result data obtained after sampling to obtain the fault distribution function of each PCBA;

In step 324, a point estimation value, upper and lower limit interval values and a failure time function of the fault distribution parameter of each PCBA is obtained according to the fault distribution function of each PCBA;

In step 326, a point estimation value and the upper and lower limit interval values of the failure time of each PCBA is obtained according to the point estimation value, the upper and lower limit interval values and the failure time function of the fault distribution parameter of each PCBA.

In step 328, the failure time of each PCBA corresponding to each second random number is obtained according to each second random number in the second preset random number set and the fault distribution function of each PCBA;

In step 330, the failure time of each PCBA is sorted and a smallest failure time is selected therefrom as the failure time corresponding to each second random number;

In Step 332, a product-level fault simulation result data is obtained according to the failure time corresponding to each second random number;

In Step 334, a distribution fitting is performed to the product-level fault simulation result data obtained after sampling to obtain the fault distribution function of the product;

In step 336, a point estimation value, upper and lower limit interval values and the failure time function of the fault distribution parameter of the product is obtained according to the fault distribution function of the product;

In step 338, a point estimation value and the upper and lower limit interval values of the failure time of the product is obtained according to the point estimation value, the upper and lower limit interval values and the failure time function of the fault distribution parameter of the product.

In step 340: a product reliability evaluation result is obtained according to the fault distribution function, the fault distribution parameter in the fault distribution parameter set, and the point estimation value and the upper and lower limit interval values of the failure time of each PCBA, and the fault distribution function, the fault distribution parameter in the fault distribution parameter value set, and the point estimation value and the upper and lower limit interval values of the failure time parameters of the product.

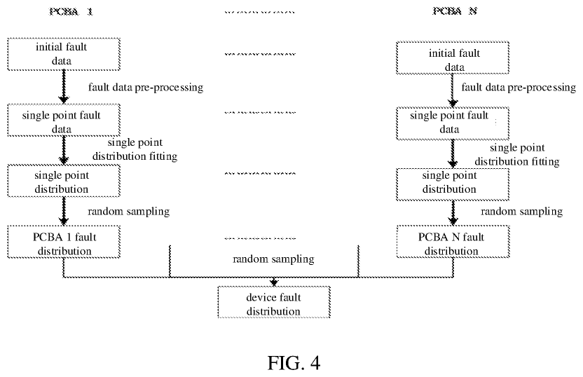

In one of the embodiments, the product reliability evaluation method of the present disclosure is illustrated by the schematic diagram shown in FIG. 4.

A first fault simulation result data of each of the preset components (that is, an initial failure data) is acquired, and a second fault simulation result data of each of the preset components is obtained according to the identification of each fault simulation result data in the first fault simulation result data (that is, a single point fault data is obtained via fault data pre-processing). A distribution fitting is performed on the second fault simulation result data to determine the fault distribution function of each of the preset components (that is, a single point distribution is obtained via a single point distribution fitting), and a data sampling is performed according to the first preset random number set and the fault distribution function of each of the preset components. A distribution fitting is performed on the PCBA-level fault simulation result data obtained after sampling to obtain the fault distribution function and fault distribution parameter value set of each PCBA. The fault distribution parameter value set includes the fault distribution parameter and the point estimation value and the upper and lower limit interval values of the failure time (that is, a fault distribution of PCBA is obtained via performing a random sampling on the single point distribution). A data sampling is performed according to the second preset random number set and the fault distribution function of each PCBA, and a distribution fitting is performed on the product-level fault simulation result data obtained after sampling to obtain the fault distribution function and the fault distribution parameter value set of the product (that is, a device fault distribution is obtained via performing a random sampling). A product reliability evaluation result is obtained according to the fault distribution function and the fault distribution parameter value set of each PCBA and the fault distribution function and the fault distribution parameter value set of the product.

It should be understood that although the various steps in the flowchart of FIGS. 2 to 3 are sequentially displayed as indicated by the arrows, these steps are not necessarily performed in the order indicated by the arrows. Unless explicitly stated herein, the performing order of the steps is not be limited strictly, and the steps may be performed in other orders. Moreover, at least part of the steps in FIGS. 2 to 3 may include a plurality of steps or phases, which are not necessary to be performed simultaneously, but may be performed at different times, and for the performing order thereof, it is not necessary to be performed sequentially, but may be performed by turns or alternately with other steps or steps of other steps or at least part of the phases.

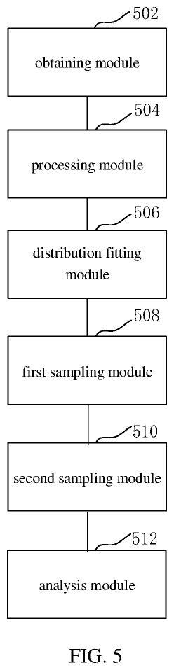

In one embodiment, as shown in FIG. 5, a product reliability evaluation device is provided including: an acquiring module 502, a processing module 504, a distribution fitting module 506, a first sampling module 508, a second sampling module 510 and an analysis module 512, where:

the acquiring module 502 is configured to acquire a first fault simulation result data of each of the preset components;

the processing module 504 is configured to obtain a second fault simulation result data of each of the preset components according to the identification of each fault simulation result data in the first fault simulation result data;

the distribution fitting module 506 is configured to perform a distribution fitting to the second fault simulation result data to determine the fault distribution function of each of the preset components;

the first sampling module 508 is configured to perform data sampling according to a first preset random number set and the fault distribution function of each of the preset components, and performing distribution fitting to the PCBA-level fault simulation result data obtained after sampling to obtain the fault distribution function and fault distribution parameter value set of each PCBA, the fault distribution parameter value set includes a fault distribution parameter, a point estimation value and the upper and lower limit interval values of the failure time;

the second sampling module 510 is configured to perform data sampling according to a second preset random number set and the fault distribution function of each PCBA, and performing distribution fitting to the product-level fault simulation result data to obtain the fault distribution function and fault distribution parameter value set of the product.

the analysis module 512 is configured to obtain a product reliability evaluation result according to the fault distribution function and fault distribution parameter value set of each PCBA and the fault distribution function and the fault distribution parameter value set of the product.

In the aforementioned device for evaluating product reliability, the first fault simulation result data of each of the preset components is acquired, and the second fault simulation result of each of the preset components is obtained according to the identification of each fault simulation result data in the first fault simulation result data. Then via performing distribution fitting to the second fault simulation result data, the accurate determination of the fault distribution function of each of the preset components is realized, and the accuracy of the evaluation is improved. After the fault distribution function of each of the components is obtained, a data sampling is performed according to the first preset random number set and the fault distribution function of each of the preset components to obtain the fault distribution function and fault distribution parameter value set of each PCBA, and a data sampling is performed according to the second preset random number set and the fault distribution function of each PCBA, and a distribution fitting is performed on the product-level fault simulation result data obtained after sampling to realize the accurate determination of the fault distribution function and the fault distribution parameter value set of the product, which improves the accuracy of the evaluation. After obtaining the accurate fault distribution function and the fault distribution parameter value set of the product, the product reliability evaluation result is obtained according to the fault distribution function and fault distribution parameter value set of each PCBA and the fault distribution function and the fault distribution parameter value set of the product. The product reliability is evaluated from multi angles such as the point estimation value and the upper and lower limit interval values of the failure time of various PCBAs and products, so as to realize an accurate evaluation of product reliability.

In one of the embodiments, the acquiring module is further used to acquire the reliability simulation result data of the product, determine the failure mechanism priority according to the reliability simulation result data, and determine the failure mechanism to be analyzed according to the failure mechanism priority and the preset failure mechanism number to be analyzed. The first fault simulation result data of each of the preset components is acquired from the reliability simulation result data according to the failure mechanism to be analyzed.

In one of the embodiments, the processing module is further configures to determine the fault simulation result data corresponding to each failure mechanism to be analyzed via the identification of each fault simulation result data in the first fault simulation result data, pre-process the fault simulation result data corresponding to each failure mechanism to be analyzed and obtain the second fault simulation result data of each of the preset components according to the pre-processed fault simulation result data.

In one of the embodiments, the distribution fitting module is further configured to obtain a hypothesis function set of each of the preset components according to the second fault simulation result data of each of the preset components, perform a fitting test on each hypothesis function in the hypothesis function set, and select the fault distribution function from the hypothesis function set according to the fitting test result.

In one of the embodiments, the first sampling module is further configured to obtain the failure time of each of the preset components corresponding to each first random number according to the first random number in the first preset random number set and the fault distribution function of each of the preset components, sort the failure time of each of the preset components, and select the smallest failure time as the failure time corresponding to each first random number, and obtain a PCBA-level failure simulation result data according to the failure time corresponding to each first random number.

In one of the embodiments, the first sampling module is further configured to perform distribution fitting to the PCBA-level fault simulation result data obtained after sampling to obtain a fault distribution function of each PCBA, and obtain a point estimation value and the upper and lower limit interval values of the fault distribution parameter of each PCBA and a failure time function of each PCBA according to the fault distribution function of each PCBA, and obtain a point estimation value and the upper and lower limit interval values of the failure time of each PCBA according to the point estimation value and the upper and lower limit interval values of the fault distribution parameter of each PCBA, and the failure time function of each PCBA.

In one of the embodiments, the second sampling module is further configured to obtain the failure time of each PCBA corresponding to each second random number according to each second random number in the second preset random number set and the fault distribution function of each PCBA, sort the failure time of each PCBA, select the smallest failure time as the failure time corresponding to each second random number, obtain a product-level fault simulation result data according to the failure time corresponding to each second random number, perform distribution fitting to the product-level fault simulation result data obtained after sampling to obtain the fault distribution function of the product, obtain a point estimation value and the upper and lower limit interval values of the fault distribution parameter of the product and the failure time function of the product according to the fault distribution function of the product, and obtain a point estimation value and the upper and lower limit interval values of the failure time of the product according to the point estimation value and the upper and lower limit interval values of the fault distribution parameter of the product and the failure time function of the product.

For the specific definition of the device for evaluating product reliability, please refer to the above definition of the method for evaluating product reliability, which will not be repeated here. Each of the above modules in the device for evaluating product reliability may be implemented in whole or in part by software, hardware and combinations thereof. Each of the above modules may be embedded in or independent of the processor in the computer apparatus in hardware forms, or may be stored in the memory of the computer apparatus in software forms, so that the processor can invoke and execute the operations corresponding to the above each module.

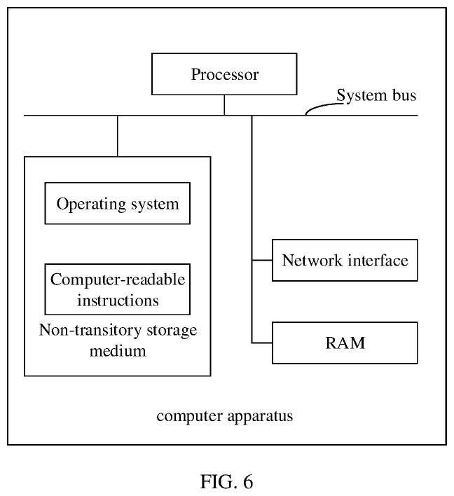

In an embodiment, a computer apparatus is provided, which may be a server, and its internal structure diagram may be as shown in FIG. 6. The computer apparatus includes a processor, a memory and a network interface connected by a system bus. The processor of the computer apparatus is configured to provide computing and control capabilities. The memory includes a non-transitory storage medium and a random access memory (RAM). The non-transitory storage medium is stored with an operating system, computer programs and a data base. The memory provides a running environment for the operating system and the computer programs in the non-transitory storage medium. The database of the computer apparatus is configured to store the first fault simulation result data, the second fault simulation result data, the fault distribution parameter set and so on. The network interface of the computer apparatus is configured to communicate with external terminals via network connections. The computer programs are executed by the processor to implement a method for evaluating product reliability.

It will be understood by those skilled in the art that the structure shown in FIG. 6 is only a block diagram of a part of the structure related to the solution of the present disclosure, and does not constitute a limitation of the computer apparatus to which the solution of the present disclosure is applied. The specific computer apparatus may include more or fewer components than those shown in the figure or combinations of some components, or have different component arrangements.

In one embodiment, a computer apparatus includes a processor, and a memory storing computer-readable instructions, which, when executed by the processor cause the processor to perform steps including:

acquiring a first fault simulation result data of each of the preset components;

obtaining a second fault simulation result data of each of the preset components according to the identification of each fault simulation result data in the first fault simulation result data;

performing distribution fitting to the second fault simulation result data to determine the fault distribution function of each of the preset components;

performing data sampling according to a first preset random number set and the fault distribution function of each of the preset components, and performing distribution fitting to the PCBA-level fault simulation result data obtained after sampling to obtain a fault distribution function and a fault distribution parameter value set of each PCBA, the fault distribution parameter value set includes a fault distribution parameter, a point estimation value and the upper and lower limit interval values of the failure time;

performing data sampling according to a second preset random number set and the fault distribution function of each PCBA, and performing distribution fitting to the product-level fault simulation result data obtained after sampling to obtain a fault distribution function and a fault distribution parameter value set of the product;

obtaining a product reliability evaluation result according to the fault distribution function and the fault distribution parameter value set of each PCBA and the fault distribution function and the fault distribution parameter value set of the product.

In one embodiment, the processor further implements the following steps when executing the computer programs: acquiring the reliability simulation result data of the product, determining the failure mechanism priority according to the reliability simulation result data, and determining the failure mechanism to be analyzed according to the failure mechanism priority and the preset failure mechanism number to be analyzed, and acquiring the first failure simulation result data of each of the preset components from the reliability simulation result data according to the failure mechanism to be analyzed.

In one embodiment, the processor further implements the following steps when executing computer programs: determining the fault simulation result data corresponding to each failure mechanism to be analyzed via the identification of each fault simulation result data in the first fault simulation result data, pre-processing the fault simulation result data corresponding to each failure mechanism to be analyzed, and obtaining the second fault simulation result data of each of the preset components according to the pre-processed fault simulation result data.

In one embodiment, the processor further implements the following steps when executing computer programs: obtaining a hypothesis function set of each of the preset components according to the second fault simulation result data of each of the preset components, performing fitting testing to each hypothesis function in the hypothesis function set, and selecting the fault distribution function from the hypothesis function set according to the fitting testing result.

In one embodiment, the processor further implements the following steps when executing computer programs: obtaining the failure time of each of the preset components corresponding to each first random number according to the first random number in the first preset random number set and the fault distribution function of each of the preset components, sorting the failure time of each of the preset components, and selecting the smallest failure time as the failure time corresponding to each first random number, and obtaining a PCBA-level failure simulation result data according to the failure time corresponding to each first random number.

In one embodiment, the processor further implements the following steps when executing computer programs: performing distribution fitting to the PBCA-level fault simulation result data obtained after sampling to obtain a fault distribution function of each PCBA, obtaining a point estimation value, upper and lower limit interval values and a failure time function of the fault distribution parameter of each PCBA according to the fault distribution function of each PCBA, and obtaining a point estimation value and the upper and lower limit interval values of the failure time of each PCBA according to the point estimation value, the upper and lower limit interval values and the failure time function of the fault distribution parameter of each PCBA.

In one embodiment, the processor further implements the following steps when executing computer programs: obtaining the failure time of each PCBA corresponding to each second random number according to each second random number in the second preset random number set and the fault distribution function of each PCBA, sorting the failure time of each PCBA, selecting the smallest failure time as the failure time corresponding to each second random number, obtaining a product-level fault simulation result data according to the failure time corresponding to each second random number, performing distribution fitting to the product-level fault simulation result data obtained after sampling to obtain the fault distribution function of the product, obtaining a point estimation value, upper and lower limit interval values and the failure time function of the fault distribution parameter of the product according to the fault distribution function of the product, and obtaining a point estimation value and the upper and lower limit interval values of the failure time of the product according to the point estimation value, the upper and lower limit interval values and the failure time function of the fault distribution parameter of the product.

In one embodiment, at least one non-transitory computer-readable storage medium is provided including computer-readable instructions, which, when executed by at least one processor cause the at least one processor to perform the steps in the foregoing methods.

A person skilled in the art should understand that the processes of the methods in the above embodiments can be, in full or in part, implemented by computer-readable instructions instructing underlying hardware. The computer-readable instructions can be stored in a computer-readable storage medium and executed by at least one processor in the computer operating system. The computer-readable instructions can include the processes in the embodiments of the various methods when it is being executed. Any references to memory, storage, databases, or other media used in various embodiments provided herein may include non-transitory and/or transitory memory. Non-transitory memory can include read only memory (ROM), programmable ROM (PROM), electrically programmable ROM (EPROM), electrically erasable programmable ROM (EEPROM), or flash memory. Transitory memory may include random access memory (RAM) or external high-speed cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), synchronization chain Synchlink DRAM (SLDRAM), memory Bus (Rambus) direct RAM (RDRAM), direct memory bus dynamic RAM (DRDRAM), and memory bus dynamic RAM (RDRAM).

Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The aforementioned embodiments merely represent several embodiments of the present disclosure, and the description thereof is more specific and detailed, but it should not be construed as limiting the scope of the present disclosure. It should be noted that, several modifications and improvements may be made for those of ordinary skill in the art, without departing from the concept of the present disclosure, and these are all within the protection scope of the present disclosure. Therefore, the protection scope of the present disclosure shall be subject to the appended claims.

What is claimed is:

1. A method for evaluating product reliability, comprising:
acquiring a first fault simulation result data of each preset component;
obtaining a second fault simulation result data of each of the preset components according to an identification of each fault simulation result data in the first fault simulation result data;
performing distribution fitting to the second fault simulation result data to determine the fault distribution function of each of the preset components;
performing data sampling according to a first preset random number set and the fault distribution function of each of the preset components, and performing distribution fitting to the PCBA-level fault simulation result data obtained after sampling to obtain the fault distribution function and the fault distribution parameter value set of each PCBA, the fault distribution parameter value set comprising a fault distribution parameter, a point estimation value, and upper and lower limit interval values of a failure time;
performing data sampling according to a second preset random number set and the fault distribution function of each PCBA, and performing distribution fitting to a product-level fault simulation result data to obtain a fault distribution function and a fault distribution parameter value set of the product; and
obtaining a product reliability evaluation result according to the fault distribution function and the fault distribution parameter value set of each PCBA, and the fault distribution function and the fault distribution parameter value set of the product.

2. The method according to claim 1, wherein the acquiring the first fault simulation result data of each of the preset components comprises:
acquiring a reliability simulation result data of the product, and determining a failure mechanism priority according to the reliability simulation result data;
determining a failure mechanism to be analyzed according to the failure mechanism priority and a preset failure mechanism number to be analyzed; and
acquiring a first failure simulation result data of each of the preset components from the reliability simulation result data according to the failure mechanism to be analyzed.

3. The method according to claim 1, wherein the obtaining the second fault simulation result data of each of the preset components according to the identification of each fault simulation result data in the first fault simulation result data comprises:
determining a fault simulation result data corresponding to each failure mechanism to be analyzed according to the identification of each fault simulation result data in the first fault simulation result data; and
pre-processing the fault simulation result data corresponding to each failure mechanism to be analyzed, and obtaining the second fault simulation result data of each of the preset components according to the pre-processed fault simulation result data.

4. The method according to claim 1, wherein the performing distribution fitting to the second fault simulation result data to determine the fault distribution function of each of the preset components comprises:
obtaining a hypothesis function set of each of the preset components according to the second fault simulation result data of each of the preset components; and
performing fitting testing to each hypothesis function in the hypothesis function set, and selecting the fault distribution function from the hypothesis function set according to the fitting test result.

5. The method according to claim 1, wherein the performing data sampling according to the first preset random number set and the fault distribution function of each of the preset components comprises:
obtaining the failure time of each of the preset components corresponding to each first random number according to each first random number in the first preset random number set and the fault distribution function of each of the preset components;
sorting the failure time of each of the preset components, and selecting a smallest failure time therefrom as the failure time corresponding to each first random number;
obtaining the PBCA-level fault simulation result data according to the failure time corresponding to each first random number.

6. The method according to claim 1, wherein the performing distribution fitting to the PBCA-level fault simulation result data obtained after sampling to obtain the fault distribution function and the fault distribution parameter value set of each PCBA comprises:
performing distribution fitting to the PBCA-level fault simulation result data obtained after sampling to obtain the fault distribution function of each PCBA;
obtaining a point estimation value, upper and lower limit interval values of the fault distribution parameter of each PCBA, and the failure time function of each PCBA according to the fault distribution function of each PCBA; and
obtaining the point estimation value and upper and lower limit interval values of the failure time of each PCBA according to the point estimation value and the upper and lower limit interval values of the fault distribution parameter of each PCBA and the failure time function of each PCBA.

7. The method according to claim 1, wherein the performing data sampling according to the second preset random number set and the fault distribution function of each PCBA, and performing distribution fitting to a product-level fault simulation result data to obtain the fault distribution function and the fault distribution parameter value set of the product comprises:
obtaining the failure time of each PCBA corresponding to each second random number according to each second random number in the second preset random number set and the fault distribution function of each PCBA;
sorting the failure time of each PCBA, and selecting a smallest failure time therefrom as the failure time corresponding to each second random number;
obtaining a product-level fault simulation result data according to the failure time corresponding to each second random number;
performing distribution fitting to the product-level fault simulation result data obtained after sampling to obtain the fault distribution function of the product;
obtaining a point estimation value, upper and lower limit interval values, and the failure time function of the fault distribution parameter of the product according to the fault distribution function of the product; and
obtaining a point estimation value and upper and lower limit interval values of the failure time of the product according to the point estimation value, the upper and lower limit interval values, and the failure time function of the fault distribution parameter of the product.

8. A computer apparatus comprising a processor; and a memory storing instructions, which, when executed by the processor, cause the processor to perform steps comprising:
acquiring a first fault simulation result data of each preset component;
obtaining a second fault simulation result data of each of the preset components according to an identification of each fault simulation result data in the first fault simulation result data;
performing distribution fitting to the second fault simulation result data to determine the fault distribution function of each of the preset components;
performing data sampling according to a first preset random number set and the fault distribution function of each of the preset components, and performing distribution fitting to the PCBA-level fault simulation result data obtained after sampling to obtain the fault distribution function and the fault distribution parameter value set of each PCBA, the fault distribution parameter value set comprising a fault distribution parameter, a point estimation value, and upper and lower limit interval values of a failure time;
performing data sampling according to a second preset random number set and the fault distribution function of each PCBA, and performing distribution fitting to a product-level fault simulation result data to obtain a fault distribution function and a fault distribution parameter value set of the product; and
obtaining a product reliability evaluation result according to the fault distribution function and the fault distribution parameter value set of each PCBA, and the fault distribution function and the fault distribution parameter value set of the product.

9. The computer apparatus according to claim 8, wherein the acquiring the first fault simulation result data of each of the preset components comprises:
acquiring a reliability simulation result data of the product, and determining a failure mechanism priority according to the reliability simulation result data;
determining a failure mechanism to be analyzed according to the failure mechanism priority and a preset failure mechanism number to be analyzed; and
acquiring a first failure simulation result data of each of the preset components from the reliability simulation result data according to the failure mechanism to be analyzed.

10. The computer apparatus according to claim 8, wherein the obtaining the second fault simulation result data of each of the preset components according to the identification of each fault simulation result data in the first fault simulation result data comprises:
determining a fault simulation result data corresponding to each failure mechanism to be analyzed according to the identification of each fault simulation result data in the first fault simulation result data; and
pre-processing the fault simulation result data corresponding to each failure mechanism to be analyzed, and obtaining the second fault simulation result data of each of the preset components according to the pre-processed fault simulation result data.

11. The computer apparatus according to claim 8, wherein the performing distribution fitting to the second fault simulation result data to determine the fault distribution function of each of the preset components comprises:
obtaining a hypothesis function set of each of the preset components according to the second fault simulation result data of each of the preset components; and
performing fitting testing to each hypothesis function in the hypothesis function set, and selecting the fault distribution function from the hypothesis function set according to the fitting test result.

12. The computer apparatus according to claim 8, wherein the performing data sampling according to the first preset random number set and the fault distribution function of each of the preset components comprises:
obtaining the failure time of each of the preset components corresponding to each first random number according to each first random number in the first preset random number set and the fault distribution function of each of the preset components;
sorting the failure time of each of the preset components, and selecting a smallest failure time therefrom as the failure time corresponding to each first random number;
obtaining the PBCA-level fault simulation result data according to the failure time corresponding to each first random number.

13. The computer apparatus according to claim 8, wherein the performing distribution fitting to the PCBA-level fault simulation result data obtained after sampling to obtain the fault distribution function and the fault distribution parameter value set of each PCBA comprises:
performing distribution fitting to the PBCA-level fault simulation result data obtained after sampling to obtain the fault distribution function of each PCBA;
obtaining a point estimation value, upper and lower limit interval values of the fault distribution parameter of each PCBA, and the failure time function of each PCBA according to the fault distribution function of each PCBA; and
obtaining the point estimation value and upper and lower limit interval values of the failure time of each PCBA according to the point estimation value and the upper and lower limit interval values of the fault distribution parameter of each PCBA and the failure time function of each PCBA.

14. The computer apparatus according to claim 8, wherein the performing data sampling according to the second preset random number set and the fault distribution function of each PCBA, and performing distribution fitting to a product-level fault simulation result data to obtain the fault distribution function and the fault distribution parameter value set of the product comprises:
obtaining the failure time of each PCBA corresponding to each second random number according to each second random number in the second preset random number set and the fault distribution function of each PCBA;
sorting the failure time of each PCBA, and selecting a smallest failure time therefrom as the failure time corresponding to each second random number;
obtaining a product-level fault simulation result data according to the failure time corresponding to each second random number;
performing distribution fitting to the product-level fault simulation result data obtained after sampling to obtain the fault distribution function of the product;
obtaining a point estimation value, upper and lower limit interval values, and the failure time function of the fault distribution parameter of the product according to the fault distribution function of the product; and
obtaining a point estimation value and upper and lower limit interval values of the failure time of the product according to the point estimation value, the upper and lower limit interval values, and the failure time function of the fault distribution parameter of the product.

15. At least one non-transitory computer-readable storage medium storing computer-readable instructions that, when executed by at least one processors, cause the at least one processor to perform steps comprising:
acquiring a first fault simulation result data of each preset component;
obtaining a second fault simulation result data of each of the preset components according to an identification of each fault simulation result data in the first fault simulation result data;
performing distribution fitting to the second fault simulation result data to determine the fault distribution function of each of the preset components;
performing data sampling according to a first preset random number set and the fault distribution function of each of the preset components, and performing distribution fitting to the PCBA-level fault simulation result data obtained after sampling to obtain the fault distribution function and the fault distribution parameter value set of each PCBA, the fault distribution parameter value set comprising a fault distribution parameter, a point estimation value, and upper and lower limit interval values of a failure time;
performing data sampling according to a second preset random number set and the fault distribution function of each PCBA, and performing distribution fitting to a product-level fault simulation result data to obtain a fault distribution function and a fault distribution parameter value set of the product; and
obtaining a product reliability evaluation result according to the fault distribution function and the fault distribution parameter value set of each PCBA, and the fault distribution function and the fault distribution parameter value set of the product.

16. The storage medium according to claim 15, wherein the acquiring the first fault simulation result data of each of the preset components comprises:
acquiring a reliability simulation result data of the product, and determining a failure mechanism priority according to the reliability simulation result data;
determining a failure mechanism to be analyzed according to the failure mechanism priority and a preset failure mechanism number to be analyzed; and
acquiring a first failure simulation result data of each of the preset components from the reliability simulation result data according to the failure mechanism to be analyzed.

17. The storage medium according to claim 15, wherein the obtaining the second fault simulation result data of each of the preset components according to the identification of each fault simulation result data in the first fault simulation result data comprises:
determining a fault simulation result data corresponding to each failure mechanism to be analyzed according to the identification of each fault simulation result data in the first fault simulation result data; and
pre-processing the fault simulation result data corresponding to each failure mechanism to be analyzed, and obtaining the second fault simulation result data of each of the preset components according to the pre-processed fault simulation result data.

18. The storage medium according to claim 15, wherein the performing distribution fitting to the second fault simulation result data to determine the fault distribution function of each of the preset components comprises:
obtaining a hypothesis function set of each of the preset components according to the second fault simulation result data of each of the preset components; and
performing fitting testing to each hypothesis function in the hypothesis function set, and selecting the fault distribution function from the hypothesis function set according to the fitting test result.

19. The storage medium according to claim 15, wherein the performing data sampling according to the first preset random number set and the fault distribution function of each of the preset components comprises:
obtaining the failure time of each of the preset components corresponding to each first random number according to each first random number in the first preset random number set and the fault distribution function of each of the preset components;
sorting the failure time of each of the preset components, and selecting a smallest failure time therefrom as the failure time corresponding to each first random number;
obtaining the PBCA-level fault simulation result data according to the failure time corresponding to each first random number.

20. The storage medium according to claim 15, wherein the performing distribution fitting to the PBCA-level fault simulation result data obtained after sampling to obtain the fault distribution function and the fault distribution parameter value set of each PCBA comprises:
performing distribution fitting to the PBCA-level fault simulation result data obtained after sampling to obtain the fault distribution function of each PCBA;
obtaining a point estimation value, upper and lower limit interval values of the fault distribution parameter of each PCBA, and the failure time function of each PCBA according to the fault distribution function of each PCBA; and
obtaining the point estimation value and upper and lower limit interval values of the failure time of each PCBA according to the point estimation value and the upper and lower limit interval values of the fault distribution parameter of each PCBA and the failure time function of each PCBA.
